(19) United States
(12) Patent Application Publication
(10) Pub. No.: US 2017/0041257 A1
(43) Pub. Date: Feb. 9, 2017

(54) Information Processing Method, Apparatus and System Based on Instant Messaging

(71) Applicant: Huawei Technologies Co., Ltd., Shenzhen (CN)

(72) Inventor: Zhiyong Duan, Shenzhen (CN)

(21) Appl. No.: 15/294,005

(22) Filed: Oct. 14, 2016

Related U.S. Application Data
(63) Continuation of application No. PCT/CN2015/076566, filed on Apr. 14, 2015.

(30) Foreign Application Priority Data
Apr. 16, 2014 (CN) 201410152509.8

(51) Int. Cl. H04L 12/58; H04L 29/08

(52) U.S. Cl. CPC H04L 51/046; H04L 67/26

(57) ABSTRACT

Embodiments provide an information processing method, apparatus, and system based on instant messaging. The information processing method based on instant messaging includes: acquiring, by a service server, a keyword included in instant messaging IM information of an IM client, querying a preset push information base according to the keyword, and returning, to the IM client, found push information matching the keyword, so that the IM client actively pushes the push information matching the keyword.

### CROSS-REFERENCE TO RELATED APPLICATIONS

This application is a continuation of International Application No. PCT/CN2015/076566, filed on Apr. 14, 2015, which claims priority to Chinese Patent Application No. 201410152509.8, filed on Apr. 16, 2014. The disclosures of the aforementioned applications are hereby incorporated by reference in their entireties.

### TECHNICAL FIELD

Embodiments of the present invention relate to Internet technologies, and in particular, to an information processing method, apparatus, and system based on instant messaging.

### BACKGROUND

With development of mobile networks and the Internet, when an individual user receives information including a potential demand, such as an arrears short messaging service message or a particular potential demand mentioned by another user during conversation; relevant information may be acquired on terminal devices such as a mobile phone terminal, a tablet computer, and a home computer; a service provider hopes to provide the individual user with information that is more timely and abundant.

An existing method is that when a user has browsed or has searched for relevant information, a service provider queries for information of a relevant attribute according to the information that has been browsed by the user or a keyword that has been used for searching, and displays the information on a screen of a user terminal device.

In the method, the service provider can provide corresponding information only after the user performs browsing or searching actively.

### SUMMARY

Embodiments provide an information processing method, apparatus, and system based on instant messaging, to overcome a problem in the prior art that a service provider can provide corresponding information only after a user performs browsing or searching actively.

According to a first aspect, the embodiments provide an information processing method based on instant messaging. The method includes acquiring, by a service server, a keyword included in instant messaging IM information of an IM client. The method also includes querying a preset push information base according to the keyword to obtain push information matching the keyword. The method also includes returning, to the IM client of a user, the found push information matching the keyword, so that the IM client actively pushes the push information matching the keyword.

With reference to the first aspect, in a first possible implementation manner of the first aspect, the acquiring, by a service server, a keyword included in instant messaging IM information of an IM client includes: receiving, by the service server, the IM information sent by the IM client; and querying, according to a preset keyword list, whether the IM information includes a keyword in the preset keyword list.

With reference to the first aspect, in a second possible implementation manner of the first aspect, the acquiring, by a service server, a keyword included in instant messaging IM information of an IM client includes: receiving, by the service server, the keyword sent by the IM client; or receiving, by the service server, the keyword sent by an IM server.

With reference to the first aspect and either of the first and second possible implementation manners of the first aspect, in a third possible implementation manner of the first aspect, if there are at least more than two pieces of the push information, before the returning, to the IM client, the found push information matching the keyword, the method includes: determining a weight of each matching push information according to an attribute value and a user attention degree of each matching push information and a degree of association between each matching push information and the keyword.

According to a second aspect, the embodiments provide an information processing method based on instant messaging. The method includes acquiring, by an instant messaging IM client, IM information of a user. The method also includes acquiring, by the IM client according to a preset keyword list, a keyword included in the IM information. The method also includes acquiring and displaying, by the IM client, push information matching the keyword, so as to actively push the push information matching the keyword before the user searches for the keyword.

With reference to the second aspect, in a first possible implementation manner of the second aspect, the acquiring push information matching the keyword includes: querying, by the IM client, a preset push information base according to the keyword to acquire the push information matching the keyword; or sending, by the IM client, the keyword to a service server, so that the service server queries a preset push information base according to the keyword and when finding the push information matching the keyword, returns the matching push information to the IM client; and receiving the matching push information returned by the service server; or sending, by the IM client, the keyword to an IM server, so that the IM server queries the service server for the push information matching the keyword and returns, to the IM client, the matching push information returned by the service server; and receiving the matching push information returned by the IM server.

With reference to the second aspect or the first possible implementation manner of the second aspect, in a second possible implementation manner of the second aspect, when the matching push information carries a weight of the matching push information, and there are at least more than two pieces of the matching push information, the displaying the push information includes: ranking and displaying each matching push information according to a weight of each matching push information; and after the acquiring and displaying push information matching the keyword, the method further includes: recording a click operation that is performed by the user on the matching push information and reporting the click operation to the service server, so that the service server collects statistics and updates a user attention degree of the matching push information according to a statistical result.

According to a third aspect, the embodiments provide a service server. The server includes a receiving module, configured to acquire a keyword included in instant messaging IM information of an IM client. The sever also includes a query module, configured to query a preset push information base according to the keyword to obtain push information matching the keyword. The server also includes a sending module, configured to return, to the IM client, the found push information matching the keyword, so that the IM client actively pushes the push information matching the keyword.

With reference to the third aspect, in a first possible implementation manner of the third aspect, the receiving module acquires the keyword included in the instant messaging IM information of the IM client, is specifically configured to: receive the IM information sent by the IM client; and query, according to a preset keyword list, whether the IM information includes a keyword in the preset keyword list.

With reference to the third aspect, in a second possible implementation manner of the third aspect, when acquiring the keyword included in the instant messaging IM information of the IM client, the receiving module is specifically configured to: receive the keyword sent by the IM client; or receive the keyword sent by an IM server.

With reference to the third aspect and either of the first and second possible implementation manners, in a third possible implementation manner of the third aspect, if there are at least more than two pieces of the push information, the service processor further includes a weight determining module, configured to: before the sending module returns, to the IM client, the found push information matching the keyword, determine a weight of each matching push information according to an attribute value and a user attention degree of each matching push information and a degree of association between each matching push information and the keyword.

According to a fourth aspect, the embodiments provide a terminal. The terminal includes an identification module, configured to acquire IM information of a user. The terminal also includes a first query module, configured to acquire, according to a preset keyword list, a keyword included in the IM information. The terminal also includes a second query module, configured to acquire and display push information matching the keyword, so as to actively push the push information matching the keyword before the user searches for the keyword.

With reference to the fourth aspect, in a first possible implementation manner of the fourth aspect, the second query module acquires the push information matching the keyword, is specifically configured to: query a preset push information base according to the keyword to acquire the push information matching the keyword; or send the keyword to a service server, so that the service server queries a preset push information base according to the keyword and when finding the push information matching the keyword, returns the matching push information to the IM client; and receive the matching push information returned by the service server; or send the keyword to an IM server, so that the IM server queries the service server for the push information matching the keyword and returns, to the IM client, the matching push information returned by the service server; and receive the matching push information returned by the IM server.

With reference to the fourth aspect or the first possible implementation manner of the fourth aspect, in a second possible implementation manner of the fourth aspect, the second query module is further configured to: when the matching push information carries a weight of the matching push information, and there are at least more than two pieces of the matching push information, rank and display each matching push information according to a weight of each matching push information; and the second query module is further configured to: after acquiring and displaying the push information matching the keyword, record a click operation that is performed by the user on the matching push information and report the click operation to the service server, so that the service server collects statistics and updates a user attention degree of the matching push information according to a statistical result.

According to a fifth aspect, the embodiments provide an information processing system, including: a terminal and a service server. The terminal is configured to acquire IM information of a user; the terminal acquires, according to a preset keyword list, a keyword included in the IM information; and the terminal acquires and displays push information matching the keyword, so that the push information matching the keyword is actively pushed to the terminal. The service server is configured to acquire the keyword included in the instant messaging IM information of the terminal; query a preset push information base according to the keyword to obtain the push information matching the keyword; and return, to the terminal, the found push information matching the keyword, so that the terminal actively pushes the push information matching the keyword.

By means of the information processing method and apparatus based on instant messaging in the embodiments, information is pushed before a user performs browsing or searching actively, which resolves a problem that a service provider cannot provide commodity information for the user actively.

### BRIEF DESCRIPTION OF THE DRAWINGS

To describe the technical solutions in the embodiments of the present invention more clearly, the following briefly describes the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a flowchart of Embodiment 1 of an information processing method based on instant messaging;

FIG. 2 is a flowchart of Embodiment 2 of an information processing method based on instant messaging;

FIG. 3A is a signaling flowchart of Embodiment 3 of an information processing method based on instant messaging;

FIG. 3B is a signaling flowchart of acquiring, by an IM client, a preset keyword list in Embodiment 3 shown in FIG. 3A;

FIG. 3C is another signaling flowchart of Embodiment 3 shown in FIG. 3A;

FIG. 4 is a signaling flowchart of Embodiment 4 of an information processing method based on instant messaging;

FIG. 5 is a schematic structural diagram of Embodiment 1 of a service processor;

FIG. 6 is a schematic structural diagram of Embodiment 2 of a service processor;

FIG. 7 is a schematic structural diagram of Embodiment 1 of a terminal; and

FIG. 8 is a schematic structural diagram of an embodiment of an information processing system based on instant messaging.

### DETAILED DESCRIPTION OF ILLUSTRATIVE EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

FIG. 1 is a flowchart of Embodiment 1 of an information processing method based on instant messaging. As shown in FIG. 1, the method of this embodiment may include the following steps.

Step 101: A service server acquires a keyword included in instant messaging IM information of an IM client.

The instant messaging (Instant Message, IM for short) information is IM information of a user in point-to-point communication or group communication, and may be IM information that is sent by another user and that is received by the IM client, or may be information sent by the user to another user by using the IM client.

Optionally, the IM information may include multiple keywords. For example, the keywords may be “insufficient call fee balance” and “gathering”. Optionally, the keyword may also be defined by using a logic expression of multiple key words. For example, when a keyword is: “arrears” and “mobile”, only IM information including both a key word “arrears” and a key word “mobile” includes the keyword; for another example, when a keyword is: “mountaineering” or “outdoors”, IM information including either of key words “mountaineering” and “outdoors” includes the keyword.

Optionally, the IM information is IM information of a user in point-to-point communication or group communication. Specifically, the IM information may be IM information received and/or sent in point-to-point communication or may be IM information received and/or sent in group communication.

Further, the service server may acquire the keyword in multiple manners.

In a possible implementation manner, the acquiring, by a service server, a keyword included in instant messaging IM information includes: receiving, by the service server, the keyword sent by the IM client; or receiving, by the service server, the keyword sent by an IM server.

Specifically, the IM client may retrieve the keyword in the IM information based on a preset keyword list, and directly send the retrieved keyword to the service server, or send the retrieved keyword to the service server by using the IM server. Further, the IM client may acquire the keyword list from the service server in advance.

In another possible implementation manner, before the acquiring, by a service server, a keyword included in instant messaging IM information, the method further includes: receiving, by the service server, the IM information sent by the IM client; and acquiring, according to a preset keyword list, the keyword included in the IM information.

That is, the keyword of the IM information may be retrieved by the IM client from the IM information or may be retrieved by the service server from the IM information sent by the IM client.

Step 102: Query a preset push information base according to the keyword to obtain push information matching the keyword.

The push information base is preset in the service server. Specifically, the push information base records at least more than two pieces of push information and a matching relationship between the at least more than two pieces of push information and keywords; one piece of push information may match one or more keywords, and one keyword may also match one or more pieces of push information.

The service server queries the preset push information base by using the keyword, to acquire the push information matching the keyword. For example, push information corresponding to a keyword “insufficient balance” may be mobile phone call fee charging push information, and push information corresponding to a keyword “gathering” may be group buying push information of a particular restaurant.

Step 103: Return, to the IM client, the found push information matching the keyword, so that the IM client actively pushes the push information matching the keyword.

Further, the matching push information may include a webpage address, an address redirected to another page in the instant messaging IM client, and a redirection portal to another client. The another page in the IM client may be a page that is not related to IM information communication and that is among multiple display pages provided by the IM client; and an interface of the another client may pop up when the redirection portal to the another client is clicked.

Optionally, the matching push information includes payment information corresponding to the matching push information, so that after displaying the matching push information, the IM client may send a payment request corresponding to the matching push information to the service server according to a click operation that is performed by the user. Further, the service server may send the payment request corresponding to the matching push information to a third-party device, so that the third-party device establishes a connection to the IM client by using the service server and completes payment.

In this embodiment, a preset push information base is queried according to a keyword included in the IM information, and push information matching the keyword is returned, which implements pushing information actively before the user performs browsing or searching, and resolves a problem that a service provider cannot actively provide information for a user.

Optionally, there may be multiple pieces of the matching push information. Further, if there are at least more than two pieces of the matching push information, before the returning, to the IM client, the found push information matching the keyword, the method further includes: determining a weight of each matching push information according to attribute values of each matching push information and a degree of association between each matching push information and the keyword.

Correspondingly, the returning, to the IM client, the found push information matching the keyword may include: ranking each matching push information according to the weight of each matching push information; and returning each ranked matching push information to the IM client.

The attribute values of each matching push information may be preset in the push information base; for example, when a provider of push information has a high priority, the push information has a high-priority attribute value, such as a relatively great attribute value. The degree of association between each matching push information and the keyword may also be preset in the push information base; for example, push information matching a keyword “notebook” may include: notebook computer push information, desktop computer push information, computer repair push information, and notepad push information, and these pieces of the push information have different degrees of association with the keyword. A higher attribute value of the matching push information and a higher degree of association between the matching push information and the keyword indicate a higher weight of the matching push information; a specific calculation method is not limited in the present invention.

For example, if the IM information includes “keyword 1”, and the push information base includes two records, which are respectively: record 1 that includes attributes such as “push information 1”, “keyword 1”, “attribute value of push information 1”, and “degree of association between push information 1 and keyword 1”, and record 2 that includes attributes such as “push information 2”, “keyword 1”, “attribute value of push information 2”, and “degree of association between push information 2 and keyword 1”, the service server may calculate a weight according to the attribute value and the association degree of the push information in each record.

Optionally, the service server may rank each push information according to a descending sequence of the weight of each matching push information. Further, if IM communication is busy, the service server may select a piece of push information having a relatively high weight, and return the selected push information to the IM client.

Further, a degree of user attention on the push information may also be considered when the weight of the push information is determined. Correspondingly, the determining a weight of each matching push information according to attribute values of each matching push information and a degree of association between each matching push information and the keyword includes: determining a weight of each matching push information according to the an attribute value and a user attention degree of each matching push information and the degree of association between each matching push information and the keyword.

The user attention degrees may be numerical values; for example, after receiving a piece of push information, a random IM client collects statistics about a total quantity of clicks performed by the user on this piece of push information; the service server may sum numerical values of the attribute values and the user attention degrees of each matching push information, each matching push information, and the degree of association between each matching push information and the keyword according to a particular weighting ratio, to obtain the weight of each matching push information. The user attention degree of the push information may also be set in the push information base; further, the user attention degree may also be updated according to an operation performed by the user on the push information. Correspondingly, after the returning the matching push information to the IM client, the method further includes: receiving a click operation that is reported by the IM client and that is performed by the user on the matching push information, and collecting statistics; and updating the user attention degree of the matching push information according to a statistical result.

Specifically, the user attention degree of the push information may be obtained by means of calculation according to a quantity of times the user performs the click operation on the push information.

Alternatively, the service server may add the weight of each matching push information to each matching push information and return each matching push information to the IM client, so that the IM client may perform ranking according to the weight of each matching push information.

After determining the weight of each matching push information, the service server does not need to rank each matching push information according to the weights; instead, the service server adds the weights to the push information and returns the weights together with the push information to the IM client, and the IM client determines a display mode of the push information according to the weights.

Optionally, the returning, to the IM client, the found push information matching the keyword may include: sending, by the service server to the IM server, the found push information matching the keyword, and returning, by the IM server, the push information to the IM client.

A service server acquires a keyword included in IM information, queries a preset push information base, and returns found push information matching the keyword to the IM client, so that the IM client presents the push information to the user, which implements pushing information actively before the user performs browsing or searching actively, and resolves a problem that a service provider cannot actively provide commodity information for the user.

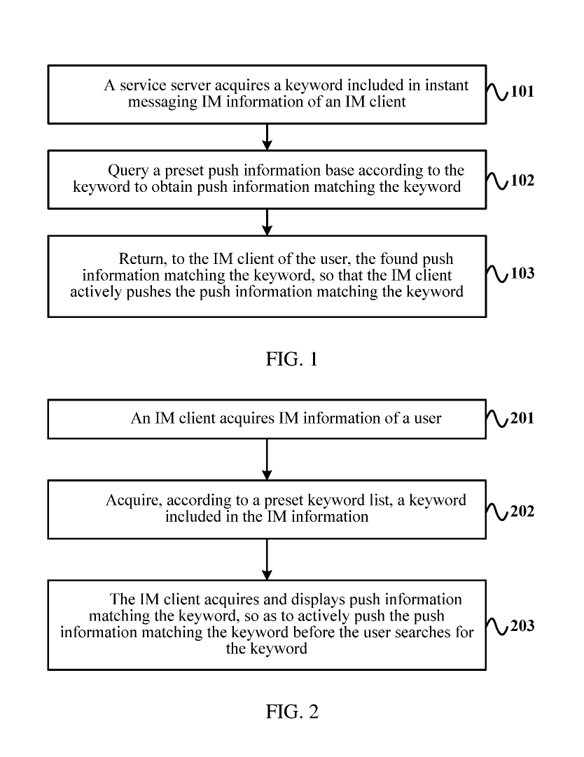

FIG. 2 is a flowchart of Embodiment 2 of an information processing method based on instant messaging. As shown in FIG. 2, the method of this embodiment may include the following steps.

Step 201, An IM client acquires IM information of a user.

The IM client may be run on user equipment such as a mobile phone, a computer, and a tablet computer. Optionally, the IM client acquires IM information of the user in point-to-point communication or group communication, and the IM information may be IM information that is sent by another user and that is received by the IM client, or may be information sent by the user to another user by using the IM client.

Step 202: Acquire, according to a preset keyword list, a keyword included in the IM information.

For example, the keyword may be “insufficient call fee balance” or “call fee”. Optionally, the keyword may be defined by using a logic expression of one or more key words. For example, when a keyword is: “arrears” and “mobile”, only IM information including both a key word “arrears” and a key word “mobile” includes the keyword; for another example, when a keyword is: “mountaineering” or “outdoors”, IM information including either of key words “arrears” and “mobile” includes the keyword.

Specifically, the IM client detects whether the IM information includes one or more keywords in the preset keyword list.

Further, the acquiring push information matching the keyword may be performed in multiple manners.

In one possible implementation manner, the acquiring push information matching the keyword includes: querying, by the IM client, a preset push information base according to the keyword to acquire the push information matching the keyword.

The preset push information base may include one or more pieces of push information and one or more keywords associated with the push information. The IM client queries the preset push information base by using the keyword, to acquire the push information matching the keyword. Before the querying, by the IM client, a preset push information base according to the keyword to acquire the push information matching the keyword, the method further includes: downloading, by the IM client, the preset push information base by sending a push information base pre-synchronization request.

In another possible implementation manner, the acquiring push information matching the keyword includes: sending, by the IM client, the keyword to a service server, so that the service server queries a preset push information base according to the keyword and when finding the push information matching the keyword, returns the matching push information to the IM client; and receiving the matching push information returned by the service server.

The IM client sends the keyword to the service server, and the IM client receives the push information matching the keyword. Content of the keyword and the push information and a relationship between the keyword and the push information are the same as those in the first situation. Details are not described herein again.

In further another possible implementation manner, the acquiring push information matching the keyword includes: sending, by the IM client, the keyword to an IM server, so that the IM server queries the service server for the push information matching the keyword and returns, to the IM client, the matching push information returned by the service server; and receiving the matching push information returned by the IM server.

Step 203: The IM client acquires and displays push information matching the keyword, so as to actively push the push information matching the keyword before the user searches for the keyword.

The IM client displays the acquired push information matching the keyword on the IM client. For example, the push information is displayed on a display interface of the IM client in a form of a piece of IM information or is displayed in a form of a system message of the IM client.

Optionally, the matching push information includes a webpage address, an address redirected to another page in the instant messaging IM client, and a redirection portal to another client.

Optionally, the matching push information includes payment information corresponding to the matching push information; after the IM client displays the matching push information, the IM client may send a payment request corresponding to the matching push information to the service server according to a click operation that is performed by the user, so that the service server may send the payment request corresponding to the matching push information to a third-party device, to enable the IM client to establish a connection to the third-party device by using the service server and complete payment.

Optionally, after the acquiring and displaying push information matching the keyword, the method further includes: recording a click operation that is performed by the user on the matching push information and reporting the click operation to the service server, so that the service server collects statistics and updates a user attention degree of the matching push information according to a statistical result.

Optionally, when the matching push information carries a weight of the matching push information, and there are at least more than two pieces of the matching push information, the displaying the push information includes: ranking and displaying each matching push information according to a weight of each matching push information.

For example, numerical values 1 to 10 may be used as weights; a greater weight numerical value, such as 10, of one piece of the matching push information indicates a higher display priority.

Optionally, after the acquiring push information matching the keyword, the method further includes: forwarding the matching push information to another IM client according to a forwarding instruction of the user.

After the IM client displays the push information, the user may operate the push information, for example, forward the push information to another IM user by using the IM client.

In this embodiment, the IM client acquires IM information, acquires, according to a preset keyword list, a keyword included in the IM information, acquires push information matching the keyword, and displays the push information on the IM client for a user to view, which implements pushing information before the user performs browsing or searching actively, and resolves a problem that a service provider cannot actively provide commodity information for the user.

Optionally, the IM server may receive the keyword that is included in the IM information and that is sent by the IM client and send the keyword to a service server, so that the service server queries the preset push information base according to the keyword and when finding the push information matching the keyword, returns the matching push information to the IM server.

The IM server may receive the push information that matches the keyword and that is returned by the service server, and returns the matching push information to the IM client.

The technical solutions of the method embodiments shown in FIG. 1 and FIG. 2 are described in detail below by using several specific embodiments.

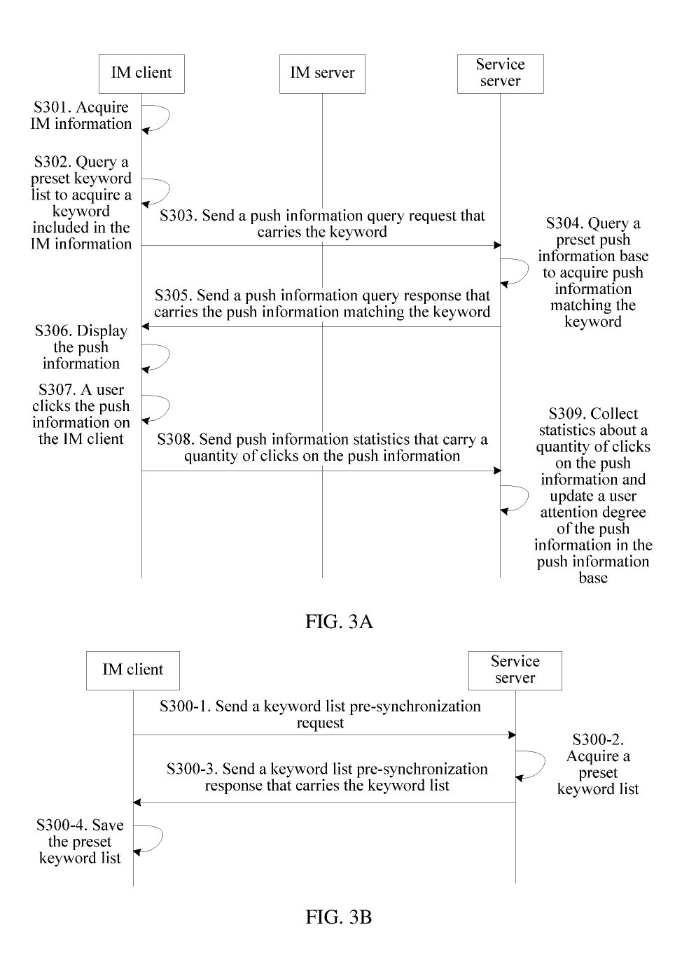

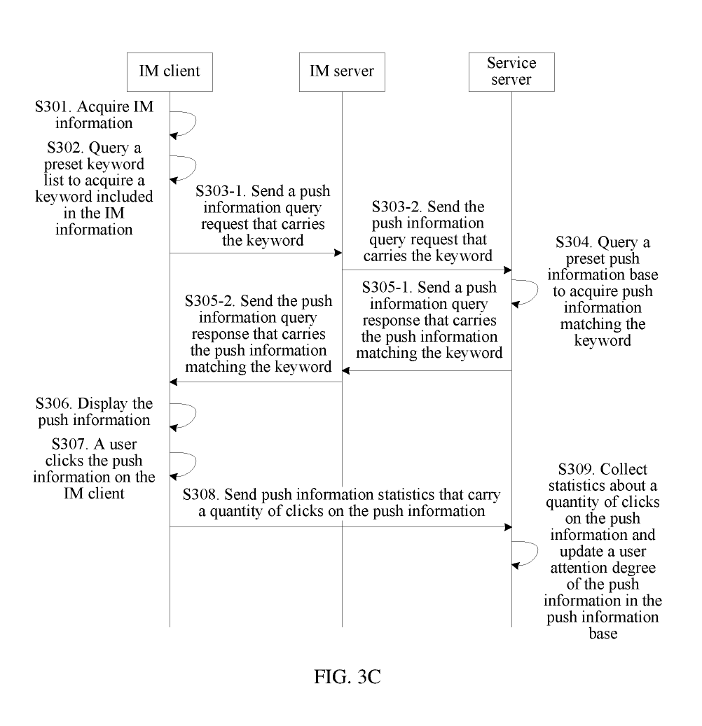

FIG. 3A is a signaling flowchart of Embodiment 3 of an information processing method based on instant messaging. As shown in FIG. 3A, the method of this embodiment may include the following steps.

S301: An IM client acquires IM information.

S302: The IM client queries a preset keyword list to acquire a keyword included in the IM information.

S303: The IM client sends, to a service server, a push information query request that carries the keyword.

S304: A service server queries a preset push information base to acquire push information matching the keyword.

S305: The service server sends, to the IM client, a push information query response that carries the push information matching the keyword.

S306: The IM client displays the push information.

S307: A user clicks the push information.

Optionally, after S307, the method may further include:

S308: The IM client sends push information statistics that carry a quantity of clicks on the push information.

S309: The service server collects statistics about a quantity of clicks on the push information, and updates a user attention degree of the push information in the push information base.

In this embodiment, the IM client acquires, according to a preset keyword list, a keyword included in IM information, acquires, from the service server, push information matching the keyword, and displays the push information on the IM client for a user to view, which implements pushing information before the user performs browsing or searching actively, and resolves a problem that a service provider cannot actively provide commodity information for the user.

FIG. 3B is a signaling flowchart of acquiring, by an IM client, a preset keyword list in Embodiment 3 shown in FIG. 3A. As shown in FIG. 3B, a step of acquiring, by an IM client, a preset keyword list includes the following steps.

S300-1: An IM client sends a keyword list pre-synchronization request to a service server.

S300-2: The service server acquires a preset keyword list.

S300-3: The service server sends, to the IM client, a keyword list pre-synchronization response that carries the keyword list.

S300-4: The IM client saves the keyword list.

In this embodiment, the IM client pre-synchronizes a keyword list, that is, the service server sends the keyword list to the IM client, so that the IM client can acquire, according to a preset keyword list, a keyword included in IM information, acquire, from the service server, push information matching the keyword, and display the push information on the IM client for a user to view, which reduces communication duration, implements pushing information before the user performs browsing or searching actively, and resolves a problem that a service provider cannot actively provide commodity information for the user.

FIG. 3C is another signaling flowchart of Embodiment 3 shown in FIG. 3A. As shown in FIG. 3C, this embodiment differs from the embodiment shown in FIG. 3A in that, in FIG. 3A, the push information query request in S303 and the response message in S305 may be forwarded by using the IM server, that is, S303 corresponds to S303-1 and S303-2 in FIG. 3C, and S305 corresponds to S305-1 and S305-2 in FIG. 3C. The method of this embodiment may further include the following steps.

S303-1: The IM client sends, to an IM server, a push information query request that carries the keyword.

S303-2: The IM server sends, to a service server, the push information query request that carries the keyword.

S305-1: The service server sends, to the IM server, a push information query response that carries the push information matching the keyword.

S305-2: The IM server sends, to the IM client, the push information query response that carries the push information matching the keyword.

Other steps: S301 to S302, S304, and S306 to S309, are the same as those in Embodiment 3 shown in FIG. 3A. Details are not described herein again.

In this embodiment, by means of forwarding by using an IM server, the IM client acquires, from the service server, push information matching the keyword and displays the push information on the IM client for a user to view; it is unnecessary to add a new interface between the IM client and the service server, and it implements pushing information before the user performs browsing or searching actively, and resolves a problem that a service provider cannot actively provide commodity information for the user.

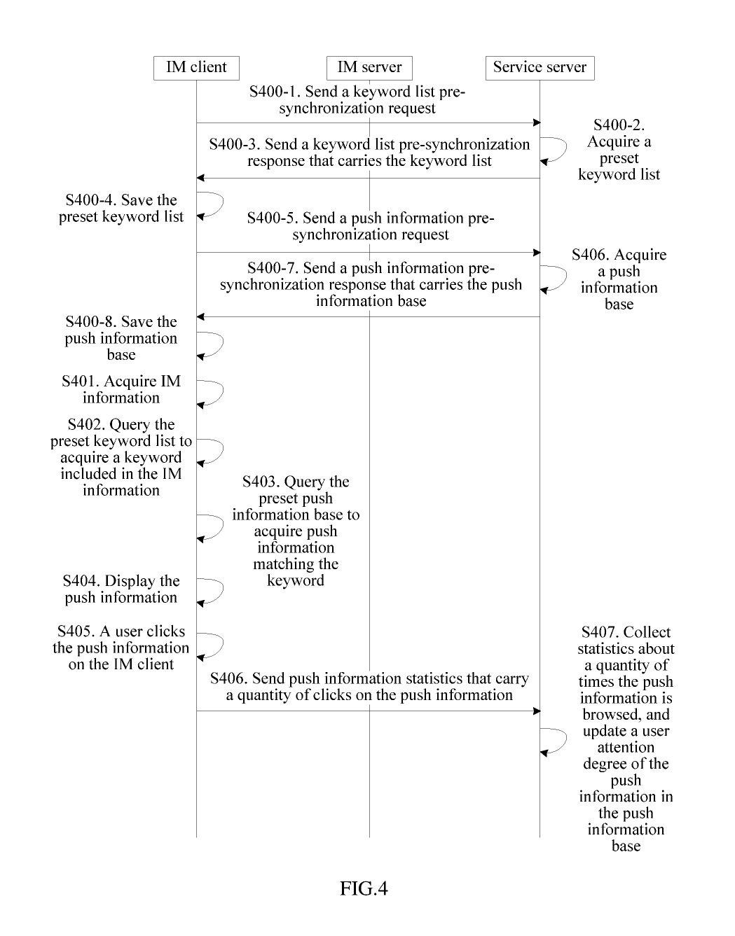

FIG. 4 is a signaling flowchart of Embodiment 4 of an information processing method based on instant messaging. As shown in FIG. 4, this embodiment differs from the embodiment shown in FIG. 3A in that, an IM client acquires a push information base in advance, and push information corresponding to a keyword is acquired on the IM client. The method of this embodiment may include the following.

S400-1: An IM client sends a keyword list pre-synchronization request to a service server.

Before the IM client sends a push information pre-synchronization request to the service server, the keyword list pre-synchronization request needs to be sent first, to ensure that a keyword list and push information belong to a same time, thereby avoiding that the push information is the latest while the keyword list is acquired earlier, and preventing a situation in which keywords in the keyword list cannot accurately match the push information cannot.

S400-2: The service server acquires a preset keyword list.

S400-3: The service server sends, to the IM client, a keyword list pre-synchronization response that carries the keyword list.

S400-4: The IM client saves the keyword list.

S400-5: The IM client sends a push information pre-synchronization request to the service server.

S400-6: The service server acquires a preset push information base.

S400-7: The service server sends, to the IM client, a push information pre-synchronization response that carries the keyword list.

S400-8: The IM client saves the push information base.

S401: The IM client acquires IM information.

S402: The IM client queries the preset keyword list to acquire a keyword included in the IM information.

S403: The IM client queries the preset push information base to acquire push information matching the keyword.

S404: The IM client displays the push information.

S405: A user clicks the push information on the IM client.

S406: The IM client sends push information statistics that carry a quantity of clicks on the push information.

S407: The service server collects statistics about a quantity of clicks on the push information, and updates a user attention degree of the push information in the push information base.

In this embodiment, the IM client pre-synchronizes a keyword list and pre-synchronizes push information, so that the IM client may locally acquire push information matching the keyword and display the push information on the IM client for a user to view, which reduces communication duration, implements pushing information actively before the user performs browsing or searching actively, and resolves a problem that a service provider cannot actively provide commodity information for the user.

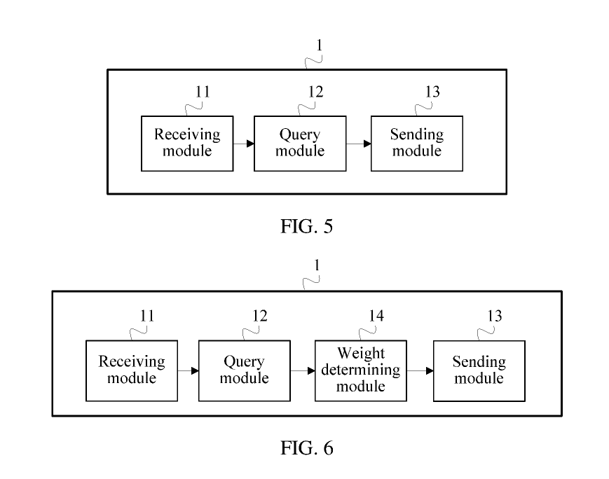

FIG. 5 is a schematic structural diagram of Embodiment 1 of a service processor. As shown in FIG. 5, a service server 1 of this embodiment may include: a receiving module 11, a query module 12, and a sending module 13, where the receiving module 11 is configured to acquire a keyword included in instant messaging IM information of an IM client; the query module 12 is configured to query a preset push information base according to the keyword to obtain push information matching the keyword; and the sending module 13 is configured to return the found push information matching the keyword to the IM client, so that the IM client actively pushes the push information matching the keyword.

Optionally, the matching push information includes a webpage address, an address redirected to another page in the instant messaging IM client, and a redirection portal to another client.

Optionally, the IM information is IM information in point-to-point communication or group communication.

Optionally, acquiring, by the receiving module 11, the keyword included in the instant messaging IM information of the IM client includes two optional implementation manners.

In one optional implementation manner, the receiving module 11 is specifically configured to: receive the IM information sent by the IM client; and query, according to a preset keyword list, whether the IM information includes a keyword in the preset keyword list.

In the other optional implementation manner, the receiving module 11 is specifically configured to: receive the keyword sent by the IM client; or receive the keyword sent by an IM server.

The apparatus of this embodiment can be used to execute the technical solutions of the method embodiments shown in FIG. 1, FIG. 3, and FIG. 4, and has a similar implementation principle and technical effect. Details are not described herein again.

FIG. 6 is a schematic structural diagram of Embodiment 2 of a service processor. As shown in FIG. 6, if there are at least more than two pieces of the push information, based on an apparatus structure shown in FIG. 5, the service server 1 of this embodiment may further include: a weight determining module 14, configured to: before the sending module 13 returns, to the IM client, the found push information matching the keyword, determine a weight of each matching push information according to an attribute value and a user attention degree of each matching push information and a degree of association between each matching push information and the keyword.

Optionally, when the sending module 13 returns, to the IM client, the found push information matching the keyword, the sending module 13 is further specifically configured to: rank each matching push information according to the weight of each matching push information; and return each ranked matching push information to the IM client.

Optionally, when the sending module 13 returns, to the IM client, the found push information matching the keyword, the sending module 13 is further specifically configured to:

add the weight of each matching push information to each matching push information and return each matching push information to the IM client.

Optionally, the acquiring module 11 is further specifically configured to: after the query module 12 returns, to the IM client, the found push information matching the keyword, receive a click operation that is reported by the IM client and that is performed by the user on the matching push information, and collect statistics; and update a user attention degree of the matching push information according to a statistical result.

The apparatus of this embodiment can be used to execute the technical solutions of the method embodiments shown in FIG. 1, FIG. 3, and FIG. 4, and has a similar implementation principle and technical effect. Details are not described herein again.

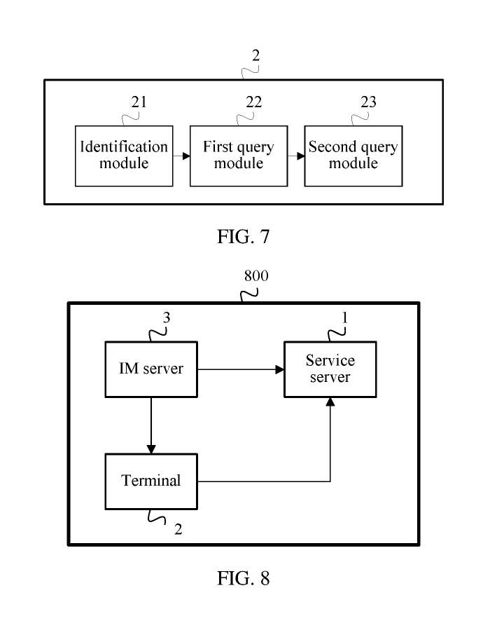

FIG. 7 is a schematic structural diagram of Embodiment 1 of a terminal. As shown in FIG. 7, a terminal 2 of this embodiment may include: an identification module 21, a first query module 22, and a second query module 23, where the identification module 21 is configured to acquire IM information of a user; the first query module 22 is configured to acquire, according to a preset keyword list, a keyword included in the IM information; and the second query module 23 is configured to acquire and display push information matching the keyword, so as to actively push the push information matching the keyword before the user searches for the keyword.

Optionally, the second query module 23 includes three optional implementation manners. In one optional implementation manner, the second query module 23 is specifically configured to: query a preset push information base according to the keyword to acquire the push information matching the keyword.

In another optional implementation manner, the second query module 23 is specifically configured to: send the keyword to a service server, so that the service server queries a preset push information base according to the keyword and when finding the push information matching the keyword, sends the matching push information to the terminal; and receive the matching push information returned by the service server.

In a third optional implementation manner, the second query module 23 is specifically configured to: send the keyword to an IM server, so that the IM server queries the service server for the push information matching the keyword and returns, to the terminal, the matching push information returned by the service server; and receive the matching push information returned by the IM server.

Optionally, when the matching push information carries a weight of the matching push information, and there are at least more than two pieces of the matching push information, the second query module 23 is further specifically configured to: rank and display each matching push information according to a weight of each matching push information.

Further, after the second query module 23 acquires and displays the push information matching the keyword, the second query module 23 may be further configured to: record a click operation that is performed by the user on the matching push information and report the click operation to the service server, so that the service server collects statistics and updates a user attention degree of the matching push information according to a statistical result.

Optionally, the matching push information includes a webpage address, an address redirected to another page in the instant messaging IM client, and a redirection portal to another client.

The apparatus of this embodiment can be used to execute the technical solutions of the method embodiments shown in FIG. 2 to FIG. 4, and has a similar implementation principle and technical effect. Details are not described herein again.

FIG. 8 is a schematic structural diagram of an embodiment of an information processing system based on instant messaging. As shown in FIG. 8, a system 800 of this embodiment includes: a service server 1, a terminal 2, and an IM server 3.

The service server 1 is configured to acquire a keyword included in instant messaging IM information of the terminal; query a preset push information base according to the keyword to obtain push information matching the keyword; and return, to the terminal, the found push information matching the keyword, so that the terminal actively pushes the push information matching the keyword.

The terminal 2 is configured to acquire IM information of a user; the terminal acquires, according to a preset keyword list, the keyword included in the IM information; and the terminal acquires and displays the push information matching the keyword, so that the push information matching the keyword is actively pushed to the terminal.

The service server 1 may use a structure of either of the apparatus embodiments in FIG. 5 and FIG. 6; the terminal 2 may use a structure of the apparatus embodiment in FIG. 7; correspondingly, the service server 1 and the terminal 2 can execute the technical solution of any method embodiment in FIG. 1 to FIG. 4, and have a similar implementation principle and technical effect. Details are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A method, comprising:
acquiring, by a service server, a keyword comprised in instant messaging (IM) information of an IM client;
querying a preset push information base according to the keyword to obtain push information matching the keyword; and
returning, to the IM client, the found push information matching the keyword, so that the IM client actively pushes the push information matching the keyword.

2. The method according to claim 1, wherein acquiring the keyword comprises:
receiving, by the service server, the IM information sent by the IM client; and
querying, according to a preset keyword list, whether the IM information comprises a keyword in the preset keyword list.

3. The method according to claim 1, wherein acquiring the keyword comprises:
receiving, by the service server, the keyword sent by the IM client; or
receiving, by the service server, the keyword sent by an IM server.

4. The method according to claim 1, wherein more than two pieces of push information matching the keyword are found, and before returning the found push information matching the keyword, the method comprises:
determining a weight of each matching push information according to an attribute value and a user attention degree of each matching push information and a degree of association between each matching push information and the keyword.

5. A method, comprising:
acquiring, by an instant messaging (IM) client, IM information of a user;
acquiring, by the IM client according to a preset keyword list, a keyword comprised in the IM information; and
acquiring and displaying, by the IM client, push information matching the keyword, so as to actively push the push information matching the keyword before the user searches for the keyword.

6. The method according to claim 5, wherein acquiring the push information matching the keyword comprises:
querying, by the IM client, a preset push information base according to the keyword to acquire the push information matching the keyword; or
sending, by the IM client, the keyword to a service server, so that the service server queries a preset push information base according to the keyword, and, when the push information matching the keyword is found, the service server sends the matching push information to the IM client; or
sending, by the IM client, the keyword to an IM server, so that the IM server queries the service server for the push information matching the keyword and returns, to the IM client, the matching push information returned by the service server.

7. The method according to claim 5, wherein the matching push information carries a weight of the matching push information, and there are more than two pieces of matching push information;
wherein displaying the push information comprises:
ranking and displaying each piece of matching push information according to a weight of each matching push information; and
wherein after acquiring and displaying push information matching the keyword, the method further comprises:
recording a click operation that is performed by the user on the matching push information and reporting the click operation to a service server, so that the service server collects statistics and updates a user attention degree of the matching push information according to a statistical result.

8. A service server, comprising:
a receiving module, configured to acquire a keyword comprised in instant messaging (IM) information of an IM client;
a query module, configured to query a preset push information base according to the keyword to obtain push information matching the keyword; and
a sending module, configured to return, to the IM client, the found push information matching the keyword, so that the IM client actively pushes the push information matching the keyword.

9. The server according to claim 8, wherein acquiring the keyword comprises:
receiving the IM information sent by the IM client; and
querying, according to a preset keyword list, whether the IM information comprises a keyword in the preset keyword list.

10. The server according to claim 8, wherein acquiring the keyword comprises:
receiving the keyword sent by the IM client; or
receiving the keyword sent by an IM server.

11. The server according to claim 8, wherein there are more than two pieces of push information that matches the keyword, and the service server further comprises a weight determining module, configured to:
before returning the found push information matching the keyword, determine a weight of each matching push information according to an attribute value and a user attention degree of each matching push information and a degree of association between each matching push information and the keyword.

12. A terminal, comprising:
an identification module, configured to acquire instant messaging (IM) information of a user;
a first query module, configured to acquire, according to a preset keyword list, a keyword comprised in the IM information; and
a second query module, configured to acquire and display push information matching the keyword, so as to actively push the push information matching the keyword before the user searches for the keyword.

13. The terminal according to claim 12, wherein acquiring the push information matching the keyword comprises:
querying a preset push information base according to the keyword to acquire the push information matching the keyword; or
sending the keyword to a service server, so that the service server queries a preset push information base according to the keyword, and, when finding the push information matching the keyword, sends the matching push information to the terminal; or
sending the keyword to an IM server, so that the IM server queries the service server for the push information matching the keyword and returns, to the terminal, the matching push information returned by the service server.

14. The terminal according to claim 12, wherein the second query module is further configured to:
when the matching push information carries a weight of the matching push information, and there are more than two pieces of the matching push information, rank and display each matching push information according to a weight of each matching push information; and
after acquiring and displaying the push information matching the keyword, record a click operation that is performed by the user on the matching push information and report the click operation to a service server, so that the service server collects statistics and updates a user attention degree of the matching push information according to a statistical result.

15. A system, comprising:
a terminal; and
a service server;
wherein the terminal is configured to:
acquire instant messaging (IM) information of a user;
acquire, according to a preset keyword list, a keyword comprised in the IM information, and acquire and display push information matching the keyword, so that the push information matching the keyword is actively pushed to the terminal; and
wherein the service server is configured to:
acquire the keyword comprised in the instant messaging (IM) information of the terminal;
query a preset push information base according to the keyword to obtain the push information matching the keyword; and
return, to the terminal, the found push information matching the keyword, so that the terminal actively pushes the push information matching the keyword.

16. A terminal, comprising:
a processor; and
a memory, wherein the memory is configured to store program instructions, and the processor is configured to execute the program instructions to perform the following:
acquire instant messaging (IM) information of a user;
acquire, according to a preset keyword list, a keyword comprised in the IM information; and
acquire and display push information matching the keyword, so as to actively push the push information matching the keyword before the user searches for the keyword.

17. The terminal according to claim 16, wherein the processor further executes the program instructions to perform the following:
query a preset push information base according to the keyword to acquire the push information matching the keyword; or
send the keyword to a service server, so that the service server queries a preset push information base according to the keyword, and, when finding the push information matching the keyword, sends the matching push information to the terminal; or
send the keyword to an IM server, so that the IM server queries the service server for the push information matching the keyword, and returns, to the terminal, the matching push information returned by the service server.

18. The terminal according to claim 16, wherein the processor further executes the program instructions to perform the following:
when the matching push information carries a weight of the matching push information, and there more than two pieces of the matching push information, rank and display each matching push information according to a weight of each matching push information; and
after acquiring and displaying the push information matching the keyword, record a click operation that is performed by the user on the matching push information and report the click operation to a service server, so that the service server collects statistics and updates a user attention degree of the matching push information according to a statistical result.

19. A service server, comprising:
a processor; and
a memory, wherein the memory is configured to store program instructions, and the processor is configured to execute the program instructions to perform the following:
acquire a keyword comprised in instant messaging (IM) information of an IM client;
query a preset push information base according to the keyword to obtain push information matching the keyword; and
return, to the IM client, the found push information matching the keyword, so that the IM client actively pushes the push information matching the keyword.

20. The server according to claim 19, wherein the processor is further configured to execute the program instructions to perform the following:
receive the IM information sent by the IM client; and
query, according to a preset keyword list, whether the IM information comprises a keyword in the preset keyword list.
